(19) United States
(12) Patent Application Publication
(10) Pub. No.: US 2006/0148379 A1
(43) Pub. Date: Jul. 6, 2006

(54) Integrated system of apiculture beehive (movable bottom board, honey and brood chamber and cover), which is made entirely of metal

(76) Inventor: Thomas Lappas, Lamia (GR)

Correspondence Address: SCHIFF HARDIN, LLP;PATENT DEPARTMENT, 6600 SEARS TOWER, CHICAGO, IL, 60606-6473, US

(21) Appl. No.: 10/544,682

(22) PCT Filed: Feb. 16, 2004
(86) PCT No.: PCT/GR04/00010

§ 371 Date: Aug. 4, 2005

(30) Foreign Application Priority Data
Feb. 14, 2003 (GR) 20030100074

(51) Int. Cl. A01K 47/00

(52) U.S. Cl. 449/29

(57) ABSTRACT

A mobile metallic base for a beehive has a front corresponding to the front of the beehive, a rear corresponding to the rear of the beehive, first and second opposing sides extending between the front and rear of the mobile metallic base and corresponding to the sides of the beehive, a first leg at the front and extending between the first and second opposing sides, and a second leg at the rear and extending between the first and second opposing sides. The first and second legs include supports that receive connectors which connect the mobile metallic base to the rest of the beehive.

### BACKGROUND OF THE INVENTION

An initial invention (GR patent 1003751) refers to an integrated system having a metal bottom board of a beehive, which includes special metal components such as a ventilation port, metal supporting legs for supporting the beehive on the ground, as well as a system for fitting the bottom board with the upper part of the beehive. The whole system of the movable bottom is used as a base for the upper part of the beehive that is made of wood. The technical field of the invention is apiculture and especially the technology of manufacturing and managing beehives during the apiarian period.

The system of the metal base with the supporting legs of the initial invention (GR patent 1003751) is improved according to the present invention. The base and the legs are made of metal and are of one piece (molten-pressed aluminum or iron). The supporting legs are transferred to the front and rear of the base, so that the connector binding the upper chamber to the base is terminated at the legs. Also, not only the bottom part but the whole system of the beehive as well is made entirely of metal instead of wood.

A bee uses a beehive as a place of residence and honey production. The beehive is made of wood (usually fir). The beehive has mainly two variations.

The first variation consists of a brood chamber, a honey chamber, and a cover. The brood chamber is attached to a fixed bottom part [the lower part of the beehive with typical dimensions 510×420×290 mm (l×w×h)] where new bees are produced. The honey chamber (immediately above the brood chamber) with typical dimensions (510×420×250) mm (l×w×h) is where honey is produced. The cover (lid) covers the beehive and has holes for ventilation at the two sides. The typical dimensions of the cover are (510×420.70) mm (l×w×h). The lower part of the beehive is waterproof and it is supported on legs (typical height of 35 mm).

The second variation of the beehive differs mainly as regards its lower part. More specifically, it consists of a movable wooden bottom board [510×420×85 (l×w×h)], two honey chambers with the same dimensions (510×420×250) (l×w×h) from which the lowest one is used as a brood chamber, and a cover (lid) such as in the first case. In this variation of the beehive, the brood chamber is attached to the movable bottom part with metal fittings and is removed easily. Consequently its replacement is easier than in the first variation.

The movable bottom board, which is made of wood, has many disadvantages such as time dependent dry rot, mechanical distortion due to humidity, and mechanical instability and difficulty to fit the bottom to the upper part of the beehive which increase with time. So the replacement, either for maintenance or transportation, becomes difficult and the apiculturer spends more time especially during the apiarian period. The average lifetime of the wooden beehive is 4-12 years depending on wood quality, general conditions, and maintenance, while a metal beehive can last for a longer time, giving also a cost advantage to the new invention.

The present invention extends and improves significantly the connection method between the removable bottom board and the upper chamber, by positioning the supporting legs at the front and rear of the beehive. (GR patent 10037510) The new version of beehive may be used to replace the first above-mentioned version of beehive, having as a main advantage the facility of carriage and fitting all the parts easily during transportation or maintenance.

### BRIEF DESCRIPTION OF THE DRAWINGS

One specific way for the materialization of this invention is described in the following figures:

FIG. 1 shows the general drawing in perspective of the invention;

FIGS. 2-7 show the details of the ground plan, the side, and the intersection views as follows:

FIG. 2a is a drawing in perspective of the movable metal bottom board together with the bee-hole and the alighting/landing board;

FIG. 2b shows a ground plan and the intersections of the movable bottom board;

FIG. 3a shows a ground plan and intersection of the brood chamber and honey chamber;

FIG. 3b is a drawing in perspective of the brood chamber and honey chamber;

FIG. 4a shows a ground plan and intersections of the cover of the beehive; and,

FIG. 4b is a perspective view of a beehive cover.

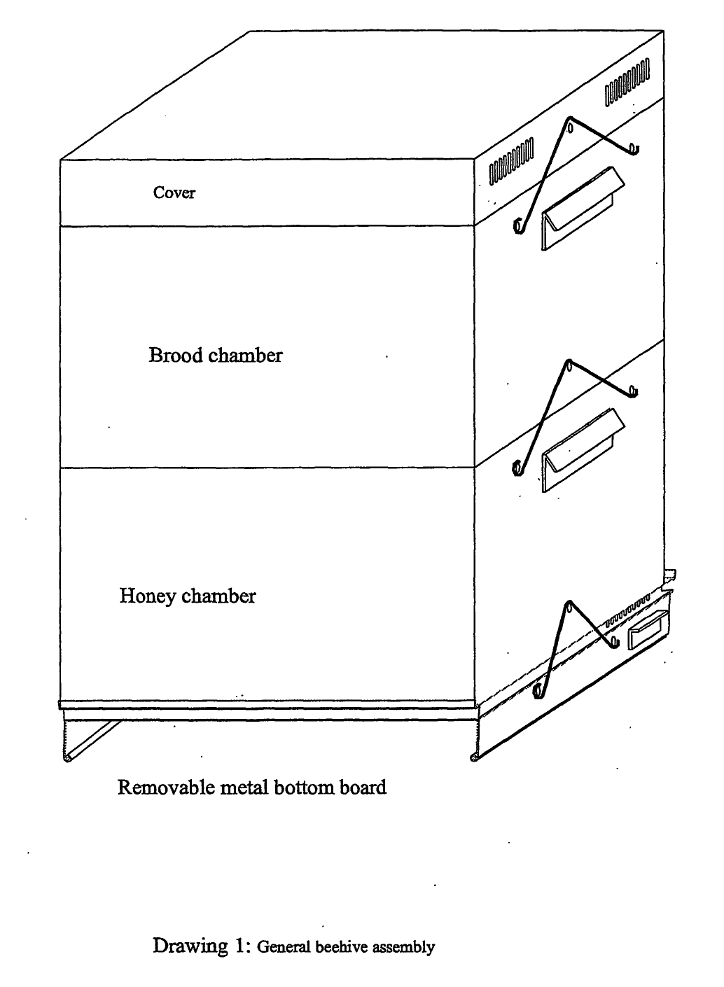

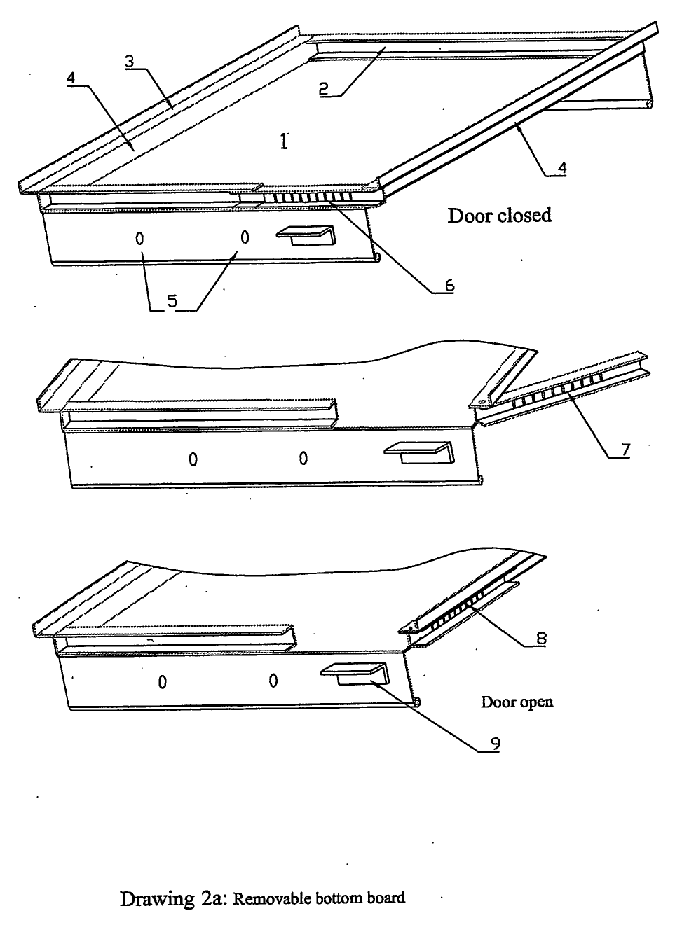

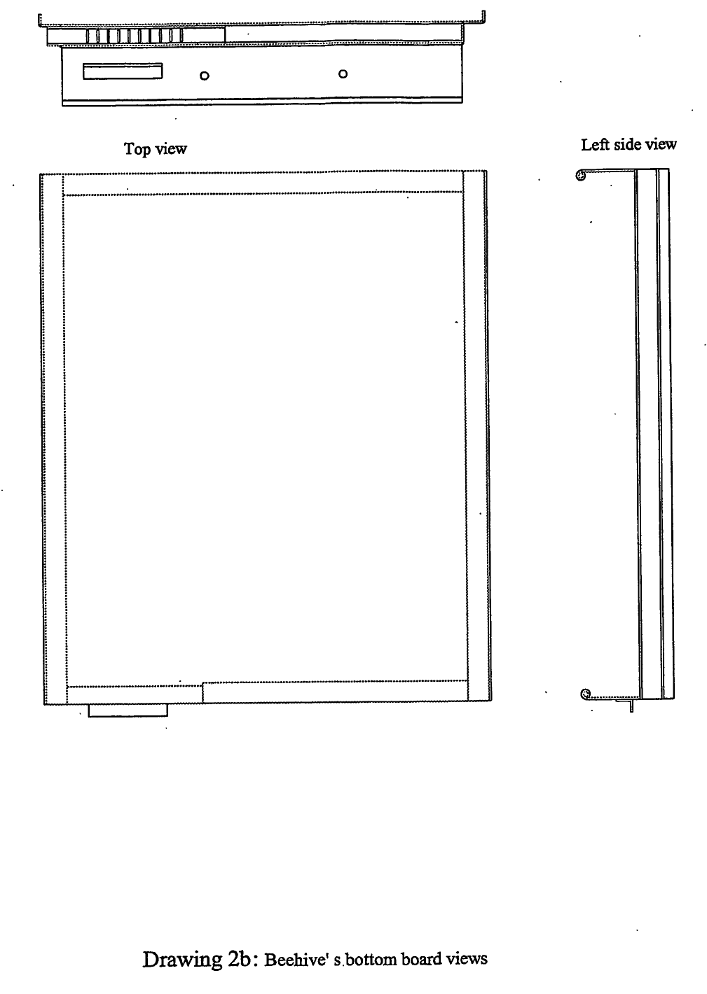

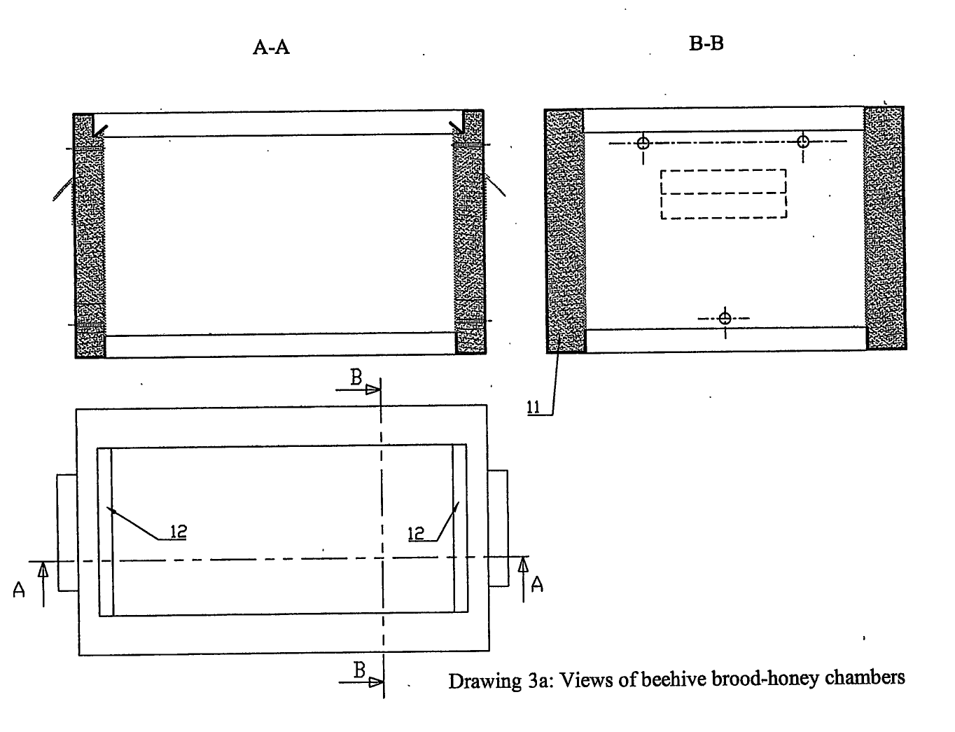

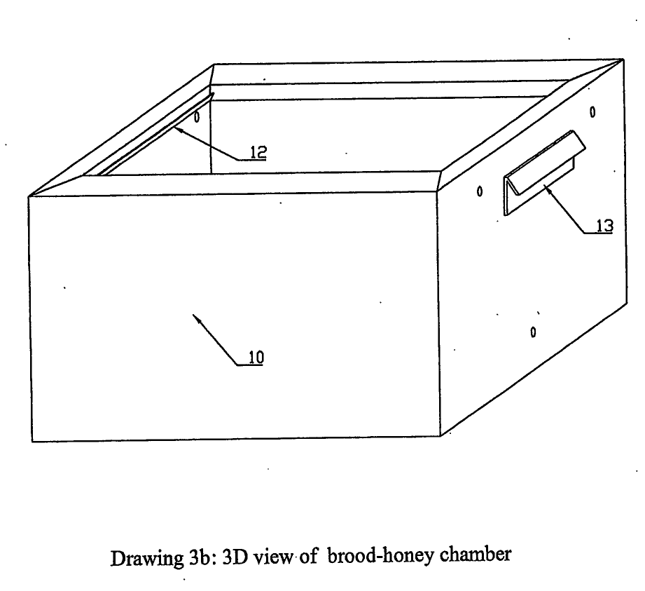

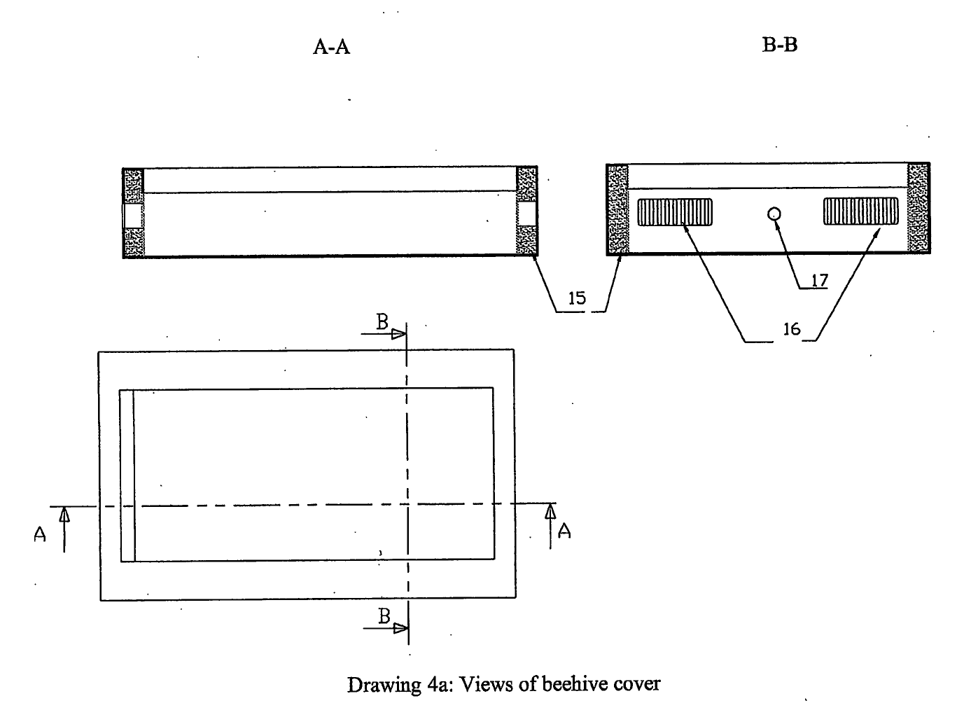

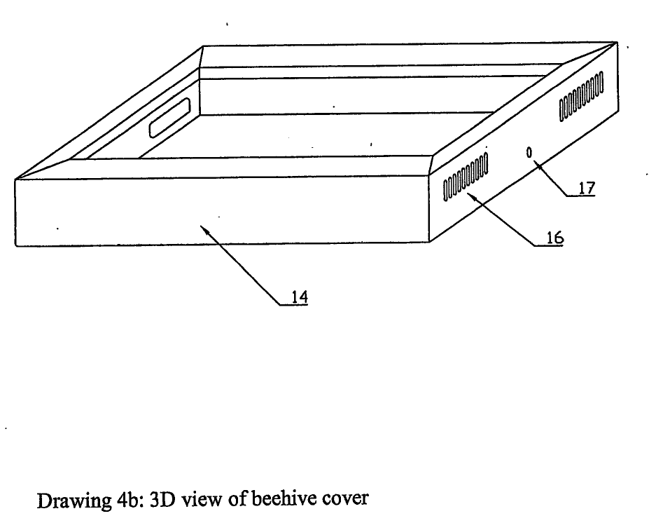

### DETAILED DESCRIPTION OF THE INVENTION

The beehive system consists of the following parts: 1. A movable metal bottom board, which is now improved and accomplishes the perfect connection; 2. A honey chamber and a brood chamber. They have typical dimensions (510×420×250) mm (l×w×h) and a thickness of material of 22 mm, and may be made of stainless metal, aluminum or galvanized metal. An insulating material is used which is made of foam or another kind of material (e.g. polyurethane, etc.) for the heat insulation of the area; 3. A cover made entirely of metal (typical dimensions 510×420×80 mm) (l×w×h) and a typical thickness of 20 mm with a heat insulation material that is used for the honey-brood chamber. The ventilation holes, which are necessary at the traditional wooden beehives for the needs of transportation of the beehive and the colony of bees, are also used here; and, 4. A fitting system for the cover and the brood chamber by using suitable connectors and fittings so as the new beehive fits perfectly to the movable metal bottom board which has already been secured.

The characteristics of the invention that make it advantageous over the existing technology are the following: 1. The metal material, unlike wood, does not rot. The wooden beehive has a life span of 4-12 years depending on the quality of the wood. More specifically the wooden bottom board, due to its contact with the ground, suffers from wear and tear because of humidity and thus it requires regular maintenance (painting). The metal beehive has a longer life span (the stainless material has a practically unlimited duration “from grandfather to grandson”). The connection between the chambers of the beehive can be done easily without any fitting problems of the movable parts as happens with the wooden ones. As a whole the cost of disinfections and maintenance is reduced for the producer; 2. Moreover the cleaning and disinfection of the floor of the beehive are easier due to the metal material. The conformity to the specifications of the system HACCP, which is applied for the production of honey, is of special importance. For example, the appearance of illnesses such as the bacillus of American and European dry rot requires the use of drugs for their fighting. In the wooden beehive, the bacillus penetrates and is absorbed by the wood and consequently its fighting is difficult. For the disinfection of the beehive, a 100° C. temperature for 10-15 min. is required. The use of a metal material deters the penetration of the bacillus and it allows the direct heating of the metal material (great conductivity, little thermal capacity). Thus the time for disinfection will be considerably less. For similar reasons, the use of wooden benches is not allowed anymore in the food industry (bread-making, pastry-making, etc) and, instead, metal ones are required; 3. The metal beehive is not flammable even in a case of crawling fire. The fitting of the beehive on the movable wooden board presents some mechanical problems. (That's why even though the wooden movable bottom is practical, it isn't used by the apiarists); 4. The fitting systems at the metal bottom board, the brood chamber, and the cover of the honey chamber solve the problems about mechanical fitting and wear and tear which in the case of the use of wood became more intense by the passing of time. Given that the transportation of the beehives may happen 6 to 12 times a year (nomadic apiculture), the existing fitting method causes important wear and tear as it has been proved in practice; 5. The particular structure is lighter than the wooden one, which facilitates apiarist's work during the transportation and maintenance of the beehive.

The movable bottom board 1 of the beehive consists of the lower part (2) (typical dimensions 380×512 and 20 mm height). The honeybees for their entrance and exit of the beehive as well as a free space for bees use this place during the inspection of the beehive. The upper part 3 of the movable bottom board has typical dimensions 422×512 and 10 mm height. The bigger dimension (4) allows for the mechanical stability of the brood chamber. On the two metal legs at the front and back of the beehive) of the movable bottom board there are the supports 5 for the fitting connector with the brood chamber. A bee-hole 6 is made at the front of the mobile floor 1. During the transportation of the beehives, a metal block 7 is put at the front of the movable bottom board 1. This block 7 can turn round at 270° and be secured at an on position an off position (8). A “flying-board” alighting/landing board 9 is put under the bee-hole 6, which is made of metal in this specific construction. The alighting/landing board 9 is for enabling bees during their return to the beehive by providing the necessary step which is at the same height with the entrance/bee-hole of the beehive.

With this proposed technique the metal movable bottom board maintains its compatibility with the existing brood chambers.

The brood-honey chambers consist of two boxes with typical dimensions of (510×420×250 mm) (l×w×h) and with a material thickness of 20 mm, which are made of stainless metal, aluminum or galvanized metal. The surrounding walls are double so as to be filled therebetween with insulating foamy material or some other kind of material (e.g. polyurethane etc) for the heat insulation of the chamber (11). In the upper part of the chamber there is the flange 12 which supports the frames, and which allows the fitting of the upper part of the beehive. On the two sides of the boxes there are handles 13 for the transportation handles.

The cover (14) is made of metal material with typical dimensions (510×420×80 mm) (l×w×h) and with a material thickness of 20 mm and heat insulation (of the same material which is used at the honey-brood chamber)(15). The holes 16 for ventilation, which there are in the traditional wooden beehive for the needs of the transportation of the colony of bees and the beehive, are also maintained here. The same type of connector 17, which is used at the lower parts of the beehive, supports the cover.

The connectors that fasten to the supports 5 are bound to the center of the front side of the honey chamber as well as to the supporting legs. The brood chamber has a similar metal notch, which in the existing technique “fastens” to the movable bottom board with the system “Barium connector”. With the proposed technique the movable bottom board maintains its compatibility with the existing brood champers.

The upper part 3 of the movable bottom board 1 has a wider dimension that a floor of the movable bottom board 1, which allows for the mechanical stability of the brood chamber. Moreover a metal flange is provided in order to provide a better mechanical stability to the movable bottom board as well as to protect against any possible escape of bees during transportation. The connectors fastened to the supports 5 are bound at the center of the front side as well as at the supporting legs, which are placed in front-end positions. The brood chamber has a similar metal notch, which in the existing technique “fastens” to the movable bottom board with the system “Barium connector.” With this technique, the movable bottom board maintains its compatibility with the existing brood champers.

1-5. (canceled)

6. A mobile metallic base for a beehive, wherein the beehive has a front, a rear, and sides, wherein bees enter the beehive at the front of the beehive, and wherein the beehive has at least one chamber, the mobile metallic base comprising:
a front corresponding to the front of the beehive;
a rear corresponding to the rear of the beehive;
first and second opposing sides, wherein the sides of the mobile metallic base extend between the front and rear of the mobile metallic base, and wherein the first and second sides of the mobile metallic base correspond to the sides of the beehive;
a first leg at the front of the mobile metallic base and extending between the first and second opposing sides of the mobile metallic base;
a second leg at the rear of the mobile metallic base and extending between the first and second opposing sides of the mobile metallic base, wherein the first and second legs include legs that receive connectors that connect the mobile metallic base to the chamber.

7. The mobile metallic base of claim 6 wherein the front of the mobile metallic base includes an opening to permit bees to enter the beehive.

8. The mobile metallic base of claim 6 wherein the mobile metallic base including the first and second legs are made of stainless sheet.

9. The mobile metallic base of claim 6 wherein the mobile metallic base including the first and second legs are made of galvanized steel.

10. The mobile metallic base of claim 6 wherein the mobile metallic base including the first and second legs are made of aluminum.

11. The mobile metallic base of claim 6 further comprising II-shaped structures at the front and rear part of the mobile metallic base that are fitted over the first and second legs so that bees do not escape the beehive during transportation.

12. The mobile metallic base of claim 11 wherein the front II-shaped structure is smaller than the rear II-shaped structure by about two fifths so that it leaves some space for the inlet and outlet of bees and accommodates a metallic slot in a “closed” position for preventing bees from entering or leaving the beehive.

13. The mobile metallic base of claim 12 wherein the metallic slot is provided with the holes for aeration during the transportation and can be rotated through an angle of 270 degrees between the closed position and an open position.

14. The mobile metallic base of claim 6 wherein any compatible joint is fitted to the first and second legs in order that the mobile metallic base can be connected to the chamber.

15. The mobile metallic base of claim 6 wherein the mobile metallic base is formed so as provided bees space for the bees during the inspection of the beehive.

16. The mobile metallic base of claim 6 wherein an upper part of the movable metallic base includes a wider dimension than a floor of the mobile metallic base to provide increased mechanical stability for the chamber.

17. The mobile metallic base of claim 6 further comprising a metal flange to provide a better mechanical stability to the movable bottom board and to protect against any possible escape of bees during the transportation.

18. The mobile metallic base of claim 6 further comprising a slot and a landing board, wherein the slot permits bees to enter and leave the beehive, and wherein the landing board is near the hole and is made of metal.

19. A beehive mobile having a front, a rear, and sides, the beehive comprising:
a mobile metallic base including a front, a rear, first and second sides, and first and second legs, wherein the front of mobile metallic base corresponds to the front of the beehive, wherein the rear of mobile metallic base corresponds to the rear of the beehive, wherein the sides of the mobile metallic base extend between the front and rear of the mobile metallic base, wherein the first and second sides of the mobile metallic base correspond to the sides of the beehive, wherein the first leg of mobile metallic base is at the front of the mobile metallic base and extends between the first and second opposing sides of the mobile metallic base, wherein the second leg is at the rear of the mobile metallic base and extends between the first and second opposing sides of the mobile metallic base, and wherein the first and second legs include legs that receive connectors that connect the mobile metallic base to the chamber;
a honey chamber that detachably fastens to the mobile metallic base by connectors that attach to the legs of the mobile metallic base;
a brood chamber that detachably fastens to the honey chamber; and,
a cover that detachably fastens to the brood chamber.

20. The beehive of claim 19 wherein the front of the mobile metallic base includes a slot to permit bees to enter the beehive.

21. The beehive of claim 20 further comprising a metal cover that can be closed over the slot to prevent an escape of bees.

22. The beehive of claim 21 wherein the cover is provided with the holes for aeration while in the closed position.

23. The beehive of claim 21 wherein the cover is fastened to the mobile metallic base so that the cover can be rotated through an angle of 270 degrees between the closed position and an open position.

24. The beehive of claim 21 wherein the mobile metallic base further includes a landing board near the slot.
